(19) United States
(12) Patent Application Publication
(10) Pub. No.: US 2012/0271681 A1
(43) Pub. Date: Oct. 25, 2012

(54) APPARATUS AND METHOD FOR PRODUCT OPTIMIZATION ON THE BASIS OF NATIONAL AND INTERNATIONAL SERIAL MEASUREMENT DATA

(76) Inventors: Andreas Seidl, Otterberg (DE); Rainer Trieb, Weilerbach (DE)

(21) Appl. No.: 13/379,391

(22) PCT Filed: Apr. 10, 2010
(86) PCT No.: PCT/EP2010/002357

§ 371 Date: Apr. 25, 2012

(30) Foreign Application Priority Data
Apr. 20, 2009 (DE) 10 2009 017 798.1

(51) Int. Cl. G06Q 30/02

(52) U.S. Cl. 705/7.33

(57) ABSTRACT

The invention relates to an apparatus and a method for product optimization taking into consideration national and/or international anthropometric or socio-demographic population characteristics, wherein the country specific data (7) (anthropometric or socio-demographic population characteristics) are stored in a central storage device (2) and evaluation queries (10) of the users are carried out via a processor (1), wherein the evaluation queries can be entered via the processor (5) of the user from an arbitrary location by means of communication devices (3, 4) using the communication connection (6). User-specific data for evaluation by the processor (5) can additionally be entered. The results of the evaluation (11) are transmitted to the processor (5) of the user and made available there to the user.

Many products which are sold in the market (products e.g. of the garment industries and car industries) require consideration already during the development of a product with respect to the measures and proportions of the human body. Based thereon it is possible to create for an existing market or a specific country properly fitting garments or ergonomically-designed vehicle inner spaces.

So far, the manufacturer of products had to depend on the available information and data from row measurements in the individual countries. These data, however, are only available in a very limited scope; they are, for instance, available in the form of printed reports with statistic-characteristic values of the determined features and these data can only be used with a respective know-how and special knowledge (in the field) by a manufacturer. Typically, this know-how is not available to the manufacturer or only in a limited form. Moreover, the results are available in different forms for the individual countries (e.g. percentized description for a one country and average values and standard deviations for another country) and as a result these data cannot directly be compared with each other and cannot be used for an evaluation covering a number of countries. Moreover the data of the row measurements differ largely with respect to the amount of data; for instance, different body measurements or differently defined measuring points are considered, so that the use of these data in the development of products or in marketing plans are very limited and require a large amount of methodical work.

Also, the WEAR-Project (World Engineering Anthropometry Resource, http://ovrt.nist.gov/projects/wear, an international initiative of research institutes) does not provide a user functionality for the evaluation directed to a specific product. The only object of the WEAR-project is the collection of anthroprometric data with purely ergonomic criteria for applications in the ergonomics.

The problem underlying the invention is to make it possible to use with the apparatus and method of the invention the data obtained in national or international row measurements as a basis for the product and market development in manufacturing entities. This comprises in particular the following basic features of the invention:
(1) Making available special evaluation functions by means of which user specific queries for different product areas can be evaluated and answered.
(2) Process data from different countries to be compatible with respect to content and representation, so that it is possible to directly compare the data and combine the data.

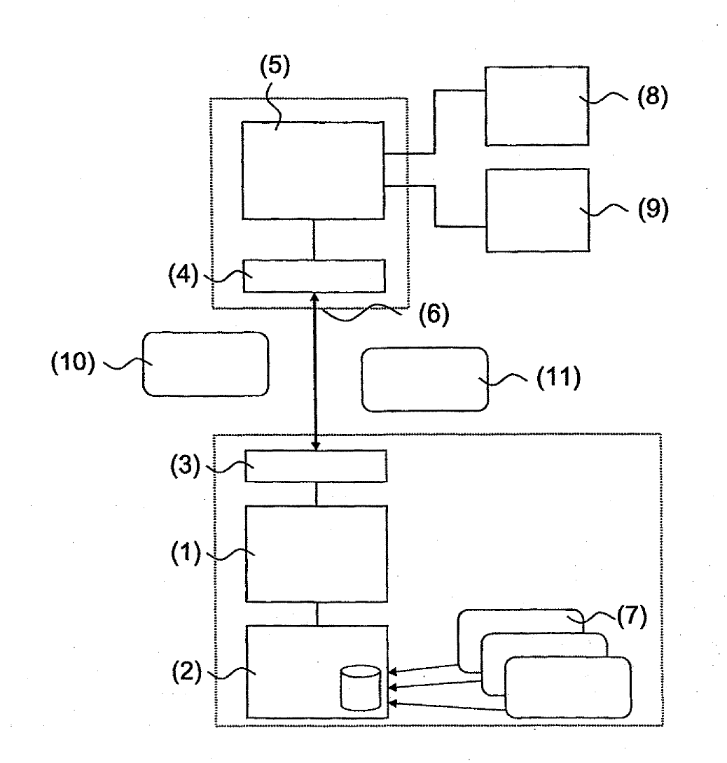

These advantages and further advantages, objects and details of the invention can be gathered from a description of an embodiment of the invention as shown in FIG. 1.

This will be explained referring to the following object:

For instance, a German garment company is interested in offering for sale its range of sizes in the French market. The company has to decide whether its range of sizes is also suitable for the French market or has to be adapted thereto.

Referring to the embodiment shown in FIG. 1, a central electronic storage means or storage device (2) is provided in which the data, which are obtained in the course of row measurements (of people) in the different countries (7), are stored. In the shown embodiment the data for each country (in the example, the results of German and French row measurements) are in individual tables (charts), with the chart (table) for each country having the same structure.

In another embodiment the data could have different structures as far as the contents are concerned.

In accordance with the invention, at first, the data are in a pre-processing step, transformed into a common compatible structure by means of suitable methods (for instance, by adapting an available result of a random sample of a country to the distribution characteristics of the body measurements of another country).

A coordinating processor (1) is connected to a communication means or device (3). The communication device (3) makes it possible that customer specific evaluation results (11) can be obtained by means of an external computer (5), which is also connected with a communication means or device (4), from any desirable location. In the embodiment, the input of the query occurs by means of a key set (9) which is connected with the external computer (5). The communication connection (6) between the two communication devices (4 and 3) can be, in an embodiment, the internet. The results of the evaluation (evaluation results) (11) of the evaluation query (10) are transmitted via the communication connection and are displayed, as shown in the embodiment, for instance on a screen (8).

The apparatus and method of the invention for optimizing a product provides, based on national and international anthroprometric or sociodemographic data of the population and user specific queries, means which provide the special evaluation functions by means of which the user specific evaluation queries for different product areas can be directly evaluated and answered.

As mentioned, at least one central storage device (2) is provided for national or international anthroprometric or sociodemographic data (7) of the population, and further at least one computer (processor) (1) is provided for carrying out the user specific evaluations on the basis of the stored population data (for instance married, two children, unmarried, divorced), wherein the at least one communication device (3) is provided to receive the evaluation queries (10) and to transmit the evaluation results (11). The communication device (3) of the apparatus can be connected to the communication device (4) of the computer (5) of a user from any location. For the connection of the communication units the means (6) for transmitting information is used. The computer (5) of the user comprises at least one input device (9) for inputting the necessary information for the evaluation query, and at least one output unit (8) for representing or visualizing the evaluation results (11). The values of the obtained data for each person, data which were measured in a row measuring program or data which were obtained by questioning (interviewing), are stored in the storage device (2).

The acquired data of a row measurement could also be stored in the form of statistical characterizing values (for instance average values, standard deviation) of said data and stored in the storage device (2). The data stored in the storage device (2) can have the form of size charts or tables, size charts which contain for each referenced size (for instance size 40) the respective ranges of data (valid ranges) of at least a measurement of the body or of another feature.

In the storage device (2) particularly the storage of 3D-shapes of objects (for instance, the shape of the body and garments) can be provided. In the storage device (2) 3D-scans in particular can be stored, wherein 3D-scans describe the surface of the body in the form of 3D point clouds, Moreover, in the storage device (2) also specific data for the product can be stored (for instance article numbers, characteristic values of material etc., data which describe the geometric or non-geometric characteristics of products.

The calculating unit (computer) (1) determines based on the information in the storage device (2) and on the basis of information from the evaluation query (10) of the user for each selected features statistic characteristic values (for instance average value, standard deviation, percentile, etc.). The computer calculates on the basis of the data or information, respectively in the storage unit (2) and on the basis of the information from the evaluation query (10) of the user as well as based on a selected size table in particular the market share of the size table. The calculation of the market shares occurs based on counting the persons who fall into the valid area of each size of the selected size table.

The computer (1) calculates based on the data in the storage unit (2) and on the basis of the evaluation query (10) of the user as well as based on a selected size table the market proportions on the basis of statistic characteristic values of the stored population data. The computer (1) calculates or selects on the basis of the data in the storage device (2), on the basis of the data from the evaluation query (10) of the user, and on the basis of the results of the calculation of the market proportions (market share) and the stored population numbers those sizes which are required to obtain a predetermined coverage of the market, or their a number which is limited by a predetermined maximum number of sizes (trade forcast).

The computer (1) changes based on the information in the storage device (2), on the basis of the data from the evaluation query (10) of the user, and at least one of the stored size charts, the value ranges of the body measurements of the sizes, such, that the market share of the size chart is increased or maximized (optimizing of size charts). The computer (1) can, based on the data in the storage device (2), on the basis of the data of the evaluation query (10) of the user calculate a size chart automatically, wherein for instance the maximum number of sizes, a selection of relevant body measurements, a market share to be reached and so on can be predetermined by the user (creation of size charts). The user can store in the storage device of the apparatus device the results of evaluations which had been carried and can access these results any time by means of his computer (5). Moreover, the user can input, store or change his own data in the storage device (2) of the apparatus by the input device (9) at his computer (5). The data can represent size charts. Moreover, the data could refer to anthroprometric or sociodemographic characteristics of the population or population data. In particular the data can be features for describing a product.

Summarizing, the invention provides an apparatus and a method for optimizing products, taking into consideration national and/or international anthroprometric or sociodemographic population characteristics or data, respectively, wherein a central storage device (12) stores the country specific data (7) (antrhoprometric or sociodemographic features of the population), and wherein by means of a computer (1) evaluation queries (10) of the user are processed, said evaluation queries can be inputted by the computer (5) of the user from any location by means of communication devices (3, 4) via the communication connection (6). In addition, user specific data for evaluation can be inputted via the computer (5). The results of the evaluation (11) are transmitted to the computer (5) of the user and are there available for the user.

1. An apparatus and a method for optimizing products taking into consideration national and international anthroprometric and sociodemographic data of the population as well as user specific evaluation queries,
wherein the apparatus comprises
at least one central storage device (2) for national or international anthroprometric or sociodemographic population data (7), at least one computer (1) for carrying out the user specific evaluations on the basis of the stored population data, and at least one communication unit (3) adapted to receive evaluation requests (10) and to transmit the evaluation results (11).

2. The apparatus of claim 1, wherein the communication device (3) of the apparatus can be temporarily connected to the communication device (4) of the computer (5) of the user, located at an optional location.

3. The apparatus of claim 1, wherein for the connection of the communication devices an information transmission means (6) (e.g. the internet, the intranet, etc.) is provided.

4. The apparatus as set forth in claim 1, wherein the computer (5) of the user comprises at least one input unit (9) for inputting the information for the evaluation query and at least one output unit (8) for the representation or visualization of the evaluation result (11).

5. The apparatus as set forth in claim 1, wherein the values of the determined data for each person, data obtained in a row measurement or based on interviews, are stored in the storage device (2).

6. The apparatus as set forth in claim 1, wherein the data acquired by a row measurement are stored in the form of statistic characteristic values (for instance average values, standard deviations, percentile values) of said acquired data in the storage device (2).

7. The apparatus as set forth in claim 1, wherein in said storage device (2) size charts are stored, said size charts for each referred size (for instance size (40) contain the respective range of values (valid ranges) of at least one body measurement or a feature.

8. The apparatus as set forth in claim 1, wherein in the storage device (2) 3D-shapes of objects (for instance body shape or form, garment) are stored.

9. The apparatus as set forth in claim 1, wherein in the storage device (2) 3D-scans are stored and wherein the 3D-scans describe the body surface in the form of 3D point clouds.

10. The apparatus as set forth in claim 1, wherein in the storage device (2) product specific data (for instance article numbers, characterizing values for materials, and so on) are stored which describe the geometric or the non-geometric characteristics of products.

11. The apparatus as set forth in claim 1, wherein the computer (1) determines on the basis of the data or information, stored in the storage device (2) and on the basis of the data of evaluation query (10) of the user for each selected feature statistic characteristic values (for instance average value, standard deviation, percentile value, etc.).

12. The apparatus as set forth in claim 7, wherein the computer (1) calculates on the basis of the data and information, respectively, stored in the storage unit (2) and on the basis of the data of the evaluation query (10) of the user, and on the basis of a selected size chart, the market share of the size chart, wherein the calculation of the market share is effected by counting the persons which fall into the valid area of each of the sizes of the selected size chart.

13. The apparatus as set forth in claim 7, wherein the computer (1) calculates, based on the data in the storage unit (2), on the basis of the data in the evaluation query (10) of the user, and based on a selected size chart the market share on the basis of statistical characteristic values of the stored population data.

14. The apparatus as set forth in claim 12 wherein the computer (1) calculates or selects on the basis of the data in the storage unit (2), on the basis of the data in the evaluation query (10) of the user, and on the basis of the results of the calculation of the market share and the stored numbers of the population those values which are required for reaching a predetermined market share or market coverage, or their number, which is limited by a predetermined maximum number of sizes (trade prognosis).

15. The apparatus as set forth in claim 7, wherein the computer (1) changes on the basis of the data in the storage unit (2), on the basis of the data in the evaluation query (10) of the user, and on at least one stored size chart, the body measure-value areas of the sizes such, that the market share of the size chart is increased or maximized (optimizing of size charts).

16. The apparatus of claim 12, wherein the computer (1) automatically calculates based on the data in the storage unit (2), and on the basis of the information in the evaluation query (10) of the user, a size chart, wherein for instance a maximum number of sizes, a selection of relevant body measures, a market share to be achieved, etc. are predetermined by the user (creating of size charts).

17. The apparatus of claim 1, wherein the user can store results of evaluations which were carried out in the storage device (2) of the apparatus and can withdraw these results with his computer (5) at any time.

18. The apparatus of claim 1, wherein the user can input his own data via the input device (9) of his computer (5) into the storage device (2) of the apparatus or can store these data or can change these data.

19. The apparatus of claim 18, wherein the data are the data of size charts.

20. The apparatus of claim 18, wherein the data are anthroprometric or sociodemographic features of the population.

21. The apparatus of claim 18, wherein the data relate features describing the product.
